(19) United States
(12) Patent Application Publication
(10) Pub. No.: US 2004/0108638 A1
(43) Pub. Date: Jun. 10, 2004

(54) Temperature control system for air/oil shock absorber module

(76) Inventor: Arnett R. Weber, Mississauga (CA)

Correspondence Address: CARLSON, GASKEY & OLDS, P.C., 400 WEST MAPLE ROAD, SUITE 350, BIRMINGHAM, MI, 48009, US

(21) Appl. No.: 10/701,997

(22) Filed: Nov. 5, 2003

Related U.S. Application Data
(60) Provisional application No. 60/430,906, filed on Dec. 4, 2002.

(51) Int. Cl. F16F 9/04

(52) U.S. Cl. 267/64.21

(57) ABSTRACT

A module consisting of a shock absorber and an air spring is provided with a control for avoiding an undesirably high temperature within the air spring. In particular, a temperature responsive valve is mounted on the air spring, and is operative when the temperature of the air spring reaches a predetermined level. At that point, the temperature responsive valve opens, allowing flow of air outwardly of the air spring. A source of cooler air is also associated with the air spring. In particular, a leveling valve opens to deliver air into the air spring, when the air volume within the air spring decreases due to opening of the temperature responsive valve. Thus, a cooler air is delivered into the air spring. The control thus automatically maintains an acceptable temperature in the air spring, even when the shock absorber reaches very high temperatures.

The application claims priority to U.S. Provisional Application No. 60/430,906 that was filed on Dec. 4, 2002.

### BACKGROUND OF THE INVENTION

The present invention relates to a temperature control system for a combined shock absorber and air spring module, wherein temperature within the air spring is controlled to avoid undesirably high temperatures.

Air spring and shock absorber modules are known, and have an air spring assembled over a shock absorber. The shock absorber typically contains oil. The module thus provides both a spring and a damping function. In certain applications, the shock absorber portion can reach a very high operating temperature, as an example, 350° F. As examples, many military applications may result in such a high temperature.

The high temperature of the shock absorber presents some design challenges, in that the air spring portion will typically have a lower maximum operating temperature. As an example, a typical air spring might only be able to withstand 200° F. Over time, and as the vehicle is in operation, the temperature of the air in the air spring will stabilize and approximate that of the shock absorber. Thus, when such air spring and shock absorber modules are utilized in high temperature applications, the air spring portion might be exposed to undesirably high temperatures.

### SUMMARY OF THE INVENTION

In a disclosed embodiment of this invention, an air spring is provided with a control which ensures the air within the air spring does not reach an undesirably high temperature. In one disclosed embodiment, the control includes a temperature responsive valve which releases air from the air spring if that air or the air spring reaches an undesirably high temperature.

The air spring is also provided with a leveling valve, as known. The leveling valve operates to ensure the suspension biased by the air spring is at a desired location relative to the vehicle frame. The leveling valve either directs additional air or evacuates air from the air spring in response to movement of the suspension relative to the vehicle frame. When utilized in combination with the temperature responsive valve, the leveling valve ensures that additional lower temperature air is injected into the air spring after the air is allowed to flow outwardly of the air spring by the temperature control valve.

These and other features of the present invention can be best understood from the following specification and drawings, the following of which is a brief description.

### BRIEF DESCRIPTION OF THE DRAWINGS

FIG. 1 shows the inventive air and oil shock absorber module in a normal operative state.

FIG. 2 shows the FIG. 1 module after air has moved outwardly of the air spring, and before the leveling valve has directed additional air into the air spring.

### DETAILED DESCRIPTION OF THE PREFERRED EMBODIMENT

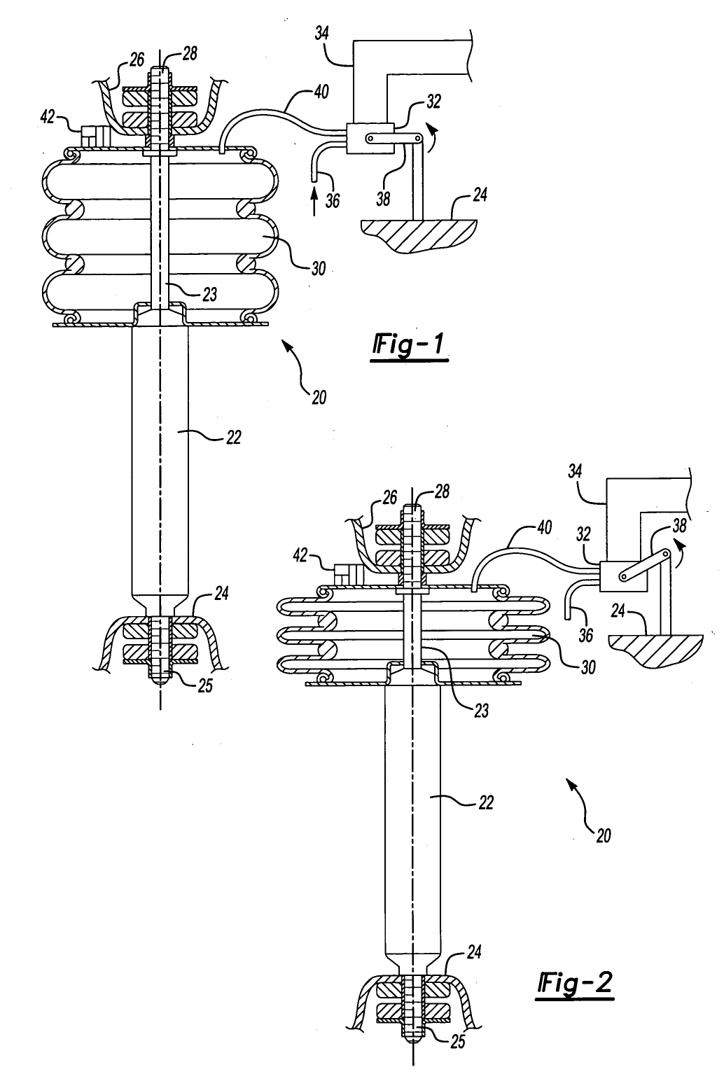

FIG. 1 shows an air spring and shock absorber module 20. As shown, the shock absorber portion 22 includes a shaft 23 extending upwardly through the air spring 30. The shock absorber 22 is mounted at 25 to the suspension 24. The other end 28 of shaft 23 is attached to vehicle frame 26. As is known, the air spring 30 is supplied with air by a leveling valve 32. Leveling valve 32 is mounted, as shown schematically at 34, to the vehicle frame. A lever 38 from the leveling valve 32 is attached to the suspension 24. A high pressure air supply line 36 delivers air to the leveling valve 32. From the leveling valve 32, air can be delivered through the line 40 into the interior of the air spring 30. The leveling valve 32 is a known component in modern vehicles, and operates to maintain the relative position of the suspension 24 and the vehicle frame 34. As the relative position of the suspension 24 changes relative to the vehicle frame 34, the lever 38 moves causing air to be delivered to, or exhausted from air spring 30, as known.

As shown, a thermostat controlled valve 42 is positioned on the air spring 30. Such valves are known, and can be designed to open at a particular temperature. That is, a thermostat control usable in this invention may be a known valve. The application of such a valve on the air spring 30 is, however, inventive. In a preferred embodiment, the thermostatic control valve is designed to open at a temperature well below the maximum operating temperature of the air spring 30, say 150° F.

Now, during operation, and particularly if the module 20 is associated with a military vehicle, the temperature of the shock absorber 22 may increase, such as up to 350° F. As this temperature rise occurs, air within the air spring 30 will also increase in temperature. At some point, the air will exceed the set point of the valve 42, and the thermostat controlled valve 42 will open. When the thermostat controlled valve 42 opens, air moves outwardly of the chamber 30, as it will be at a higher pressure than the surrounding environment.

As shown in FIG. 2, after the air has left the thermostat controlled valve 42, the air spring 30 is somewhat collapsed. When this occurs, the suspension 24 will be closer to the vehicle frame 26 than was the case in FIG. 1. With this movement, the operating lever 38 also moves, opening leveling valve 32. As the leveling valve 32 is opened, air is delivered from supply line 36 to line 40, and into the chamber of the air spring 30. This additional air drives the air spring back to its fully expanded position such as shown in FIG. 1. Replacing the hot air within the air spring 30 with the cooler air from the supply line 36 lowers the temperature of the air spring. Thus, the inventive combination provides a simple, automatic temperature control which will avoid undesirably high temperatures in the air spring.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An air spring and shock absorber module comprising:
an air spring defining an air volume, said air spring surrounding a portion of a shock absorber, said shock absorber extending within said air spring; and
a control for avoiding an undesirably high temperature within said air spring by replacing hotter air with cooler air.

2. A module as set forth in claim 1, wherein said control incorporates a temperature responsive valve that opens to allow air to leave said air volume if a predetermined temperature is reached.

3. A module as set forth in claim 2, wherein a leveling valve is operative to deliver said cooler air into said air spring should said temperature responsive valve open to allow air to leave said air volume.

4. A module as set forth in claim 2, wherein said temperature responsive valve is mounted in an end of said air spring.

5. An air spring and shock absorber module and system for reducing and regulating the air temperature within the air spring comprising:
an air spring defining an air volume, said air spring surrounding a portion of a shock absorber, said shock absorber extending within said air spring;
a temperature responsive valve provided on said air spring to monitor temperature within said air spring and to release hot air from said air volume when a predetermined temperature is reached;
an air supply line for providing air from a vehicle's air supply system; and
a leveling valve on said air supply line for enabling the flow of air from said air supply line into said air volume when a suspension which is to be attached to said shock module moves due to a release of hot air from said air volume.
